(19) United States
(12) Patent Application Publication
(10) Pub. No.: US 2014/0205375 A1
(43) Pub. Date: Jul. 24, 2014

(54) Steering Spindle Arrangement

(71) Applicants: Axel Hebenstreit, Stuttgart (DE); Hans- Dieter Loeffler, Reutlingen (DE); Thorsten Meyer, Wildberg (DE)

(72) Inventors: Axel Hebenstreit, Stuttgart (DE); Hans- Dieter Loeffler, Reutlingen (DE); Thorsten Meyer, Wildberg (DE)

(73) Assignee: DAIMLER AG, Stuttgart (DE)

(21) Appl. No.: 14/237,287

(22) PCT Filed: Aug. 3, 2012
(86) PCT No.: PCT/EP2012/003320

§ 371 Date: Apr. 3, 2014

(30) Foreign Application Priority Data
Aug. 6, 2011 (DE) 10 2011 109 689.6

(51) Int. Cl. F16D 1/08; B62D 1/20

(52) U.S. Cl. CPC F16D 1/08; B62D 1/20
USPC 403/374.2; 403/373

(57) ABSTRACT

A steering arrangement includes a steering spindle having a steering spindle connection connected to a fork crown of a steering coupling via an intermediate piece. The steering spindle connection and the intermediate piece, which is designed as a hub, are formed as plug partners at ends facing each other, by means of at least one tongue and groove guide element pair positioned in the axial longitudinal direction, which provides a torque-transmitting priority control. Torque-transmitting priority control is achieved by a first guide element arranged on the steering spindle connection, a second guide element of the guide element pair arranged on the intermediate piece, and a clamping device that clamps the plug partners together in a plugging position.

### BACKGROUND AND SUMMARY OF THE INVENTION

Exemplary embodiments of the invention relate to a steering spindle arrangement of a motor vehicle on the interface of the steering spindle with the steering coupling.

Existing direct screwing of the bottom of the steering spindle with the steering coupling is only possible in the combined field of exhaust gas assemblies, catalytic converters, engines and transmission lines with considerable effort. Here, the steering spindle is screwed in at the bottom with the steering coupling transverse to the steering spindle direction. This has the disadvantage of poor accessibility. Further, this increases the number of variants for optimizing the accessibility for different engine types and steering assemblies, for example left-hand and right-hand drive steering models, and, in addition, standard assembly sequences, such as the time of assembling the exhaust gas assembly, are hardly or not at all adhered to. In another approach regarding the configuration of the device, the steering coupling part is dispensed with and only the steering spindle at the bottom is used, wherein, however, a start-up of the engine in the Z direction during the final assembly, so the conflation of the pre-assembled engine/transmission and chassis unit, is, disadvantageously, not possible.

German patent document DE 10 2008 006 497 A1 describes an assembly arrangement for connecting a steering spindle to a steering coupling. The end piece of the steering spindle is inserted into an end receiving region of the steering coupling, wherein the assembly arrangement comprises a device for fundamentally achieving the coaxial alignment of the steering spindle and the steering coupling. Thus, the automatic conflation of the steering spindle with the steering coupling is enabled, since a manual, coaxial alignment of the steering spindle and the steering coupling can be avoided. To that end, the steering spindle has a hooking element at the end, into which a strap loop protruding from the end receiving region of the steering coupling is mounted before the final assembly. By pulling on the loop of the strap, the hooking element, together with the end piece of the steering spindle, is inserted into the end receiving region of the steering coupling so as to be screwed in there.

German patent document DE 10 2005 006 251 A1 addresses the problem of simplifying the assembly of a steering spindle on a motor vehicle. To that end, the steering spindle, which can be connected at one end to a steering wheel and at the other end to a steering gear via a steering coupling, has a cylinder body and a piston rod body inserted telescopically therein. The steering spindle has a pneumatic connection in communication with a cylinder chamber arranged in the cylinder body and is axially delineated by the piston rod body, wherein the piston rod body is driven out from the cylinder body by an application of pressure on the cylinder chamber. Thus, the spindle end provided for the connection to the steering coupling does not have to be drawn into the engine bay by hand, but can be introduced into the engine bay by the application of pressure without it being necessary to touch the spindle end. Here, the steering spindle end and steering coupling are also screwed in transversely to the steering spindle direction.

Due to the tight construction space conditions, the steering train normally impedes the assembly of the engine module with the body. The provision of an intermediate piece, which connects the steering coupling to the end of the steering spindle, enables this to be able to be swiveled away in the loose state, i.e. unscrewed, at the interface at which it is screwed in with the end of the steering spindle, in order to simplify the assembly of the engine module. The steering spindle can be pushed back to some extent in the steering wheel direction. After the assembly of the engine, the intermediate piece must be reconnected to the end of the steering spindle. This is extremely difficult for the person doing the assembling, since the construction space for a manual operation hardly leaves any clearance and the connection partners are very difficult to detect optically.

Exemplary embodiments of the present invention are directed not only to simplifying the conflation of steering spindle end and steering coupling, but also to creating an arrangement that enables the conflated steering spindle and steering coupling ends to be connected to each other in the correct relative position.

A first embodiment of the steering arrangement according to the invention has a steering spindle with a steering spindle connection, which is connected to a fork crown of a steering coupling via an intermediate piece with a hub-like design. Here, the steering spindle connection and the intermediate piece are formed according to the invention as plug partners on ends that face each other, for the purpose of which they are equipped with at least one tongue and groove guide element pair positioned in the longitudinal axial direction, which provides a torque-transmitting priority control. A first guide element of the guide element pair is arranged on the steering spindle connection and a second guide element corresponding to the first is arranged on the intermediate piece. In addition, the steering arrangement provides a clamping device that clamps the plug partners together in a plugging position.

Due to the guide elements according to the invention, which can be readily touched and/or seen by an assembler, the steering spindle and the intermediate piece of the coupling may, in an advantageously simpler manner, be combined, wherein they always assume the correct relative position to each other due to the pre-determined guiding. The clamping device connects the plug partners by means of contact pressure force in such a way that undesired release of the plug partners during the vehicle operation is prevented.

The guide elements formed by groove and tongue extend solely along the steering spindle axle. Therefore, a clamp-free manageability of the plug partners, which is easy for the assembler to embody, is enabled for achieving the plug connection.

Thus, the steering spindle connection can have one or more longitudinally axially-positioned groove(s) as (a) guide element(s) on its end facing the intermediate piece on its cylindrical exterior, while the intermediate piece is equipped on its end facing the steering spindle connection with one or, accordingly, more corresponding tongue(s) on its cylindrical interior, wherein at least one groove is present on the steering spindle connection for each tongue. Naturally, it is generally also conceivable to provide the grooves in the intermediate piece and the tongues on the steering spindle connection, or to arrange both on both plug partners interchangeably. It should be ensured that the grooves differ from one another in terms of their width. This of course also applies for the corresponding tongues that are designed with a negative shape. It is thus possible for the desired angular position of the plug partners to be guaranteed during assembly. In an incorrect position, the plug partners cannot be plugged together, which is detected immediately by the assembler either by touching or seeing.

At this point, it should be noted that an exchange of the plugging shapes of steering spindle and steering coupling is also possible. In other words, the steering spindle can have the hub (intermediate piece) at its end and the steering coupling can be embodied as a spline shaft on its end that is to be connected to the steering spindle.

In a preferred embodiment, the plugging partners have three grooves and tongues that are positioned in the longitudinal axial direction with 120° displacement to one another, whereby higher torsional moments can be advantageously transferred by the plug partners in their final plugging position without any damage.

Furthermore, in one embodiment in which the groove(s) is/are present on the steering spindle connection, provision is made for at least one longitudinal axial groove to pass into an extensive annular groove on its end facing away from the intermediate piece, while the intermediate piece bears a sleeve that can be moved relative to the intermediate piece and has one or more protrusions extending radially inwards from the edge of the sleeve on a steering-spindle-side end, the protrusions engaging with the annular groove that forms a stop with its coupling-side edge when in the plugging position. The clamping device can thus be formed in such a way that it presses the stops against one another.

Furthermore, these protrusions can be formed as gears, wherein they can be moved in a longitudinal groove, in particular in the groove of the steering spindle connection serving as a guide element, whereby the sleeve is axially guided. After the axial groove has passed through, the sleeve can be rotated in the annular groove in the peripheral direction into a rotational position, from which an axial rearward displacement is no longer possible. The projections serving as stops can be provided as a group of three, which are offset from one another by 120° in the peripheral direction, such that a tilted position of the sleeve on the steering spindle connection is prevented.

An internal peripheral groove can be provided on the coupling-side end of the sleeve, into which groove a retainer ring is inserted. This comes to rest on a stop formed by a stepped tapering, which has the intermediate piece on a section surrounded by the coupling-side end of the sleeve.

The clamping device, which presses the plug partners onto each other, can, in one embodiment, comprise a downwardly-extruding annular collar that extends radially outwards from the steering-spindle-side end on the intermediate piece, a helical spring that is located around the intermediate piece and that is supported at one end on the annular collar, and a locking device that holds back the helical spring releasably in a pre-stressed position. However, in a released helical spring arrangement, the helical spring adjoins the retainer ring arranged in the groove of the sleeve. Thus, by loosening the locking device in a simple manner in a highly compact construction type, the locking device is released, which automatically clamps the plug partners together by releasing its clamping energy.

In one embodiment, a release pin is provided as a locking device for the helical spring in order to hold this in the strongly pre-stressed position, the pin being introduced radially into a longitudinal hole that is located with peripheral positioning on the sleeve, and a radial opening of the intermediate piece is releasably positioned in a penetrating manner. The radial opening is located on the section of the intermediate piece that is enclosed by the coupling-side end of the sleeve. The longitudinal hole of the sleeve is thus arranged above an inlet of the radial opening. After the desired plugging position of both plug partners has been achieved and a rotational position of the sleeve has been obtained, the pin is pulled manually from the outside to release the locking device. By releasing the support at the end of the helical spring, this then expands in the longitudinal direction and pulls the stop surfaces of the projections together with the edge of the annular groove.

In order that the steering spindle connection can be introduced into the intermediate piece that is enclosed by the sleeve, in which piece the spring clamping device is held in a clamped position by means of the pin, a recess that opens out at the end is provided on its coupling-side end to receive the release pin, wherein the recess is in alignment with the opening of the intermediate piece with respect to its direction of passage in the plugging position.

An alternative locking device to the pin consists in a latching mechanism, which is arranged in the intermediate piece and which is acted on by a coupling-side front side of the end of the steering spindle connection that is to be absorbed into the intermediate piece. The latching mechanism thus has a latching device such as a locking tab or a catch holding the helical spring in the pre-stressed position. The actuation of the latching mechanism by the introduced front side of the steering spindle connection causes a transfer of the helical spring to the released helical spring arrangement. Thus, a manual operation of the locking device is no longer required.

Finally, advantageous embodiments of the steering arrangement apply to the fact that the guiding groove has a safety catch formed by a tapered expansion of the groove on an inlet opening for the tongue. Alternatively, a pointed design of the tongues can entail an enlarged catch range. Thus, the plug partner equipped with the tongue can automatically be guided into the correct plugging position if this is positioned on the plug partner with the groove with slight displacement in the peripheral direction. If several grooves are provided on a single plug partner, a groove and the corresponding tongue have the safety catch, with which a preferential direction is predetermined in the peripheral direction.

Additionally or alternatively, the guiding groove can be aligned with the tongue in terms of its shape, wherein the groove has a dual-wedge shape, in particular over its entire length. The edges of the groove reach apart at an angle from each other in the radial direction towards the tongue and/or the tongue tapers in the longitudinal axial direction from the inlet opening. Due to the dual-wedge shape, during a clamping of the plug partners, a particularly firm gripping of the plug connection is created as a result of the wedged clamping achieved. If the grooves (and the tongues) are designed as a dual wedge, the stop is axially separated from the counter-stop in the case of a clamping device that has not yet been released, such that, when the clamping device is released by loosening the locking device, the tapered surfaces of the groove and tongue can first be jammed together until the stops come to rest against each other.

These and other advantages are demonstrated by the description below with reference to the accompanying figures. The reference to the figures in the description serves to support the description and to facilitate understanding of the subject matter. The figures are only a schematic depiction of an embodiment of the invention.

### BRIEF DESCRIPTION OF THE DRAWING FIGURES

Here are shown:

FIG. 1 a perspective view of the steering spindle connection,

FIG. 2 a perspective view of the sleeve,

FIG. 3 a perspective view of the intermediate piece,

FIG. 4 a longitudinal section view of the steering spindle connection, sleeve and intermediate piece in the plugging arrangement,

FIG. 5 a cross-sectional view through the steering spindle connection, sleeve and intermediate piece in the plugging arrangement.

### DETAILED DESCRIPTION

The device according to the invention relates to a steering arrangement having an intermediate piece in a hub-like design, which connects the fork crown of the steering coupling to the steering spindle connection.

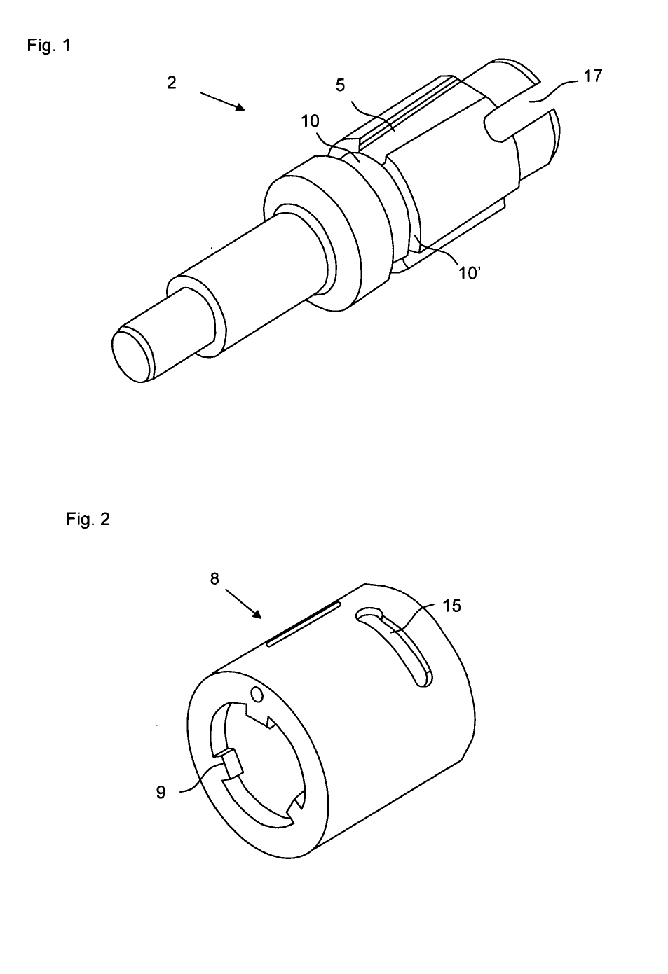

An embodiment of such a steering arrangement 1 can be seen in FIG. 4. The ends of the intermediate piece 3 and the steering spindle connection 2, which face each other, of the steering spindle are formed as plug partners that have guide elements 5, 6 that interact with each other (cf. FIGS. 1 and 3) and provide a torque-transmitting priority control. The steering arrangement 1 furthermore provides a clamping device, by means of which the plug partners can be clamped together in a plugging position, and which is implemented in FIG. 4 by the helical spring 7, which enables a clearance-free connection.

Due to the guide elements, which are shown by way of example in FIGS. 1 and 3 as grooves 5 and tongues 6, which can be readily touched and seen by the assembler during assembly, the steering spindle connection 2 and the intermediate piece 3 can be combined simply, wherein they always assume the correct relative position to each other due to the aforementioned guide. The clamping device, here a helical spring 7, connects the plug partners 2, 3 by means of contact pressure in such a way that, as described below by means of a positive connection, an undesired release of the plug partners during the driving operation is prevented.

In the present case, the guide elements are formed by three grooves 5 and three tongues 6 (or even bars), which extend solely along the A-A axis of the steering spindle. Thus a clamp-free manageability of the plug partners 2, 3, which is easy for the assembler to embody, is enabled for achieving the plug connection. Other guide elements are also conceivable in line with the invention.

The plug connection is illustrated below with the aid of the embodiment depicted in the figures, in which the grooves 5 are located on the steering spindle connection 2 and the tongues 6 are located on the intermediate piece 3. Should a correspondingly reversed arrangement of groove and tongue be provided, the developments can be readily transferred by the person skilled in the art.

Furthermore, the steering arrangement 1 can have a safety catch for both plug partners 2, 3, which is particularly formed by the guiding groove 5 diverging in a tapered manner at least at the inlet opening. Thus, the plug partner equipped with the tongue 6 can automatically be guided into the correct plugging position if this is positioned on the plug partner with the groove 5 with slight displacement in the peripheral direction.

As is depicted in FIGS. 1 and 3, the plug partners 2, 3 preferably have three respective grooves 5 or tongues 6, which are arranged with 120° displacement to one another on the outer or inner periphery. Higher torsional moments can also be hereby transferred without damage from the plug partners 2, 3 in their final plugging position. A groove 5 and the corresponding tongue 6 can thus have the safety catch, such that a preferential direction is predetermined in the peripheral direction.

Furthermore, groove 5 and tongue 6 can be extensively aligned onto each other in terms of their shape, wherein the groove 5 has a dual-wedge shape over its entire length, i.e. the edges of the groove reach apart from each other at an angle. During a clamping of the plug partners 2, 3, a particularly firm gripping of the plug connection is hereby created as a result of the wedged clamping achieved.

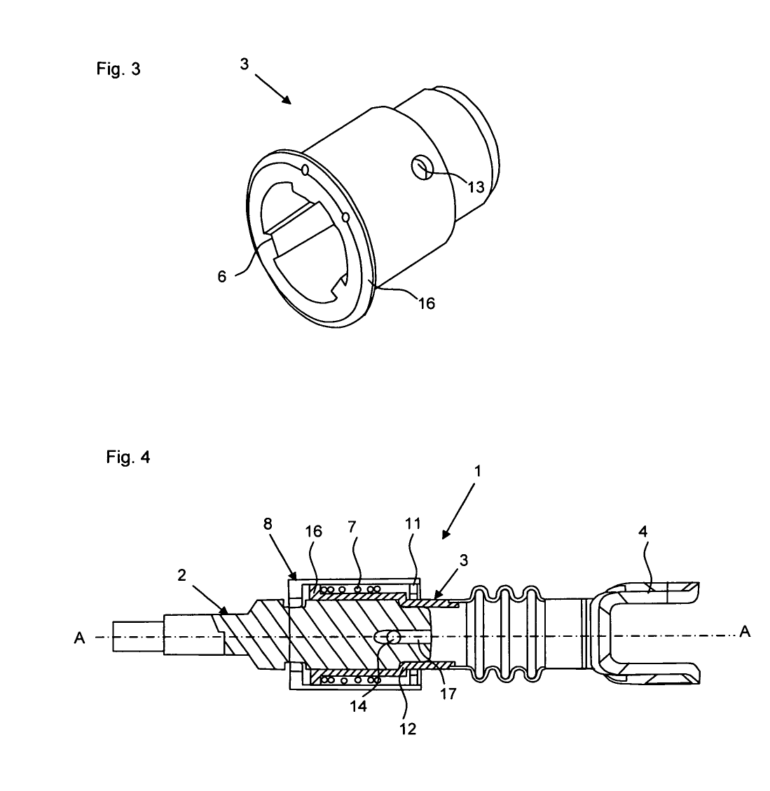

The receiving plug partner, in this case the intermediate piece 3, preferably undetachably bears a sleeve 8 that can be moved relative thereto, which engages behind a counter-stop 10′ of the partner to be received, here the steering spindle connection 2, in a plugging position of the plug partners 2, 3 with at least one stop 9 formed on the interior (FIG. 2), wherein the clamping device 7 presses the stops 9, 10′ against each other.

In the case of a clamping device that has not yet been released, the stop 9 is axially separated from the counter-stop 10′, such that, when the clamping device 7 is released, first the stops 9, 10′ come to rest on each other, whereupon the tapered surfaces of the groove 5 and tongue 6 can be jammed together.

The stop 9 of the sleeve 8 is formed as a gear-like projection 9 and can be moved in a longitudinal groove, in particular in the groove 5 of the steering spindle connection 2 that serves as a guide element, with which the sleeve 8 is axially guided.

The counter-stop is formed by the edges 10′ of an annular groove 10, into which the axial groove 5 of the steering spindle connection 2 serving as a guide element runs. After the axial groove 5 has been passed through, the sleeve 8 assumes a rotational position as a result of a rotation in the peripheral direction, from which an axial rearward displacement is no longer possible.

The three stops 9 depicted here with 120° displacement from one another in the peripheral direction prevent a tilting position of the sleeve 8 on the steering spindle connection 2.

The clamping device 7 is, as can be seen in FIG. 4, formed by a helical spring 7, which bears the receiving intermediate piece 3 and is supported with one end against an outwardly-extruding annular collar 16 of the intermediate piece 3, wherein it is supported with the other end in the clamped state on the locking device, in this case on the release pin 14, and in the released state on the retainer ring 11 of the sleeve 8.

This retainer ring 11 is arranged in the end region of the sleeve 8, which lies opposite the stops 9 formed on the other end. The clamping device 7 is released in a simple manner in a highly compact construction by unlocking the locking device, the clamping device automatically clamping the plug partners to each other by releasing its clamping energy.

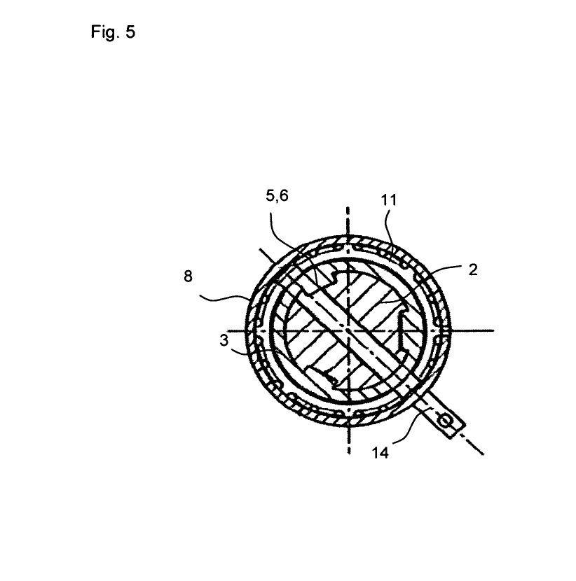

The retainer ring 11 is formed here, by way of example, as a circlip 11. In one variant, which is illustrated in a cross-section in FIG. 5, a ring 11 having a clear external gearing system is provided, the gears of which are embedded into the material of its bearing body 8 when there is a force acting in an axial preferential direction, and thus form a support with a high level of resistance.

The locking element of the locking device can, as per FIG. 4, be a pin 11 that can potentially be equipped with an outlet ring, and which pushes through a longitudinal hole 15 of the sleeve 8 (cf. FIG. 2), which runs in the peripheral direction, and pushes through a peripheral opening 13 of the receiving intermediate piece 3 (cf. FIG. 3), wherein, after the desired plugging position of both plug partners 2, 3 and rotational position of the sleeve 8 have been achieved, the pin 11 is pulled manually outwards. Due to the release of the longitudinal hole 15, the opening 13 and, above all, the support of the end of the helical spring 7, this expands in the longitudinal direction and pulls the stop surfaces 9, 10′, as well as the tapered surfaces of the groove 5 and tongue 6 of the plug partners 2, 3, together.

An elegant locking device, which is not depicted here, shows a latching device that is arranged in the receiving plug partner—the intermediate piece 3—and that is acted on by the front side of the end of the other plug partner—the steering spindle connection 2—that is immersed into the intermediate piece 3. The locking device, which can be a latch, catch or similar and which until then has locked the helical spring 7, is equipped, whereupon the spring 7 is released. Thus, a manual operation of the locking device is no longer required. In fact, this takes place as a result of the insertion movement of the plug partners 2, 3 into each other after the suitable rotational position of the sleeve 8 has been achieved.

Finally, an optical assembly control (not shown in the figures) can be provided, which automatically communicates to the assembler whether the assembly has been carried out correctly. For this, a colored pin, for example, can be used, which is connected to a coil of the helical spring on the annular collar of the receiving plug partner. As long as the helical spring is stressed, the pin is partially driven out from its guide and can be seen. If the helical spring is released, the coil withdraws somewhat from the annular collar, whereby the pin is taken with it. The pin is completely pulled into its guide and can no longer be seen. The assembler detects that the assembly has been carried out correctly and the plug connection has been achieved in a desired manner.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof

1-10. (canceled)

11. A steering arrangement, comprising:
a steering spindle having a steering spindle connection connected to a fork crown of a steering coupling via a hub-like intermediate piece, wherein the steering spindle connection and the hub-like intermediate piece are formed as plug partners on ends facing each other by means of at least one tongue and groove guide element pair, which is positioned in a longitudinal axial direction and which provides a torque-transmitting priority control;
a first guide element of the guide element pair arranged on the steering spindle connection,
a second guide element of the guide element pair arranged on the intermediate piece, and
a clamping device configured to clamp the plug partners together in a clamping position.

12. The steering arrangement according to claim 11, wherein
at least one groove is provided in the longitudinal axial direction on a cylindrical exterior of the end of the steering spindle connection facing the intermediate piece, and
at least one tongue is provided in the longitudinal axial direction on the intermediate piece.

13. The steering arrangement according to claim 12, wherein the at least one groove comprises three grooves arranged with 120° displacement to one another, and the at least one tongue comprises three tongues.

14. The steering arrangement according to claim 12, wherein
the at least one longitudinal axial groove, on its end facing away from the intermediate piece, passes into a peripheral annular groove provided on the steering spindle connection, and
the intermediate piece bears a sleeve moveable relative to the intermediate piece, the sleeve including one or more protrusions extending radially inwards from an edge of the sleeve on a steering-spindle-side end of the sleeve, the one or more protrusions engaging with the annular groove in a plugging position, which forms a stop with its coupling-side edge.

15. The steering arrangement according to claim 14, wherein the one or more protrusions are designed in a form of gears.

16. The steering arrangement according to claim 14, wherein
an inner peripheral groove is provided on the coupling-side end of the sleeve, into which a retainer ring is inserted, and
the intermediate piece has a step-like tapering to a section enclosed by the coupling-side end of the sleeve, the tapering forming, in the plugging arrangement, a stop for the retainer ring.

17. The steering arrangement according to claim 11, wherein the clamping device comprises:
a downwardly-extruding annular collar extending radially outwards on the intermediate piece;
a helical spring located around the intermediate piece supported at one end against the annular collar, and
a locking device, which releaseably holds the helical spring back in a pre-stressed position,
wherein, in a released helical spring arrangement, the helical spring adjoins the retainer ring arranged in the groove of the sleeve.

18. The steering arrangement according to claim 17, wherein
a radial opening is located on a section of the intermediate piece that is enclosed by the coupling-side end of the sleeve,
the sleeve has a peripherally-positioned longitudinal hole that is arranged above an inlet of the radial opening, and
the locking device is a release pin that is introduced radially into the longitudinal hole and the radial opening and is releasably positioned in a penetrating manner.

19. The steering arrangement according to claim 18, wherein the steering spindle connection has, on its coupling-side end, a recess that is open at the end, in which the release pin arranged in the opening of the intermediate piece is guided, wherein the recess is in alignment with the opening of the intermediate piece with respect to its direction of passage in the plugging position.

20. The steering arrangement according to claim 17, wherein
the locking device comprises a latching mechanism that is arranged in the intermediate piece and that is acted on by a coupling-side front side of the end of the steering spindle connection that is to be absorbed into the intermediate piece,
the latching mechanism comprises a latching device, in a form of a locking tab or a catch, which holds the helical spring in the pre-stressed position, and
actuation of the latching mechanism by the introduced front side of the steering spindle connection provides a transfer of the helical spring to the released helical spring arrangement.

21. The steering arrangement according to claim 12, wherein the at least one groove of the tongue and groove guide element pair
has a safety catch formed by a tapered expansion of the at least one groove on an inlet opening for the tongue or formed by a pointed groove, or
corresponds to the tongue in terms of its shape, wherein the at least one groove has a dual-wedge shape extending away over its entire length, and wherein edges of the at least one groove reach apart at an angle from each other in the radial direction towards the tongue or the at least one groove tapers in the longitudinal axial direction from the inlet opening.
